(19) United States
(12) Patent Application Publication
(10) Pub. No.: US 2004/0035278 A1
(43) Pub. Date: Feb. 26, 2004

(54) Punching apparatus

(76) Inventor: Pei-Yuan Lee, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/617,083

(22) Filed: Jul. 10, 2003

(30) Foreign Application Priority Data
Aug. 23, 2002 (TW) 091119180

(51) Int. Cl. B26F 1/14

(52) U.S. Cl. 83/684

(57) ABSTRACT

A punching apparatus includes a main body, a sustaining structure and a non-linear levering rod. The main body is used for receiving therein the article and exerting a punching force on an article to punch holes. The sustaining structure is used for transmitting a depressing force to the main body by depressing the main body to provide the punching force in response to an external force. The non-linear levering rod comprises a force-receiving portion, a pivot portion and a bent portion. The force-receiving portion is applied thereonto the external force. The pivot portion is coupled to the main body for allowing the levering rod to pivot relative to the main body in response to the external force. The bent portion is connected to the force-receiving portion and the pivot portion for keeping the force-receiving portion at a substantially horizontal level in a rest state.

### FIELD OF THE INVENTION

The present invention relates to a punching apparatus, and more particularly to a punching apparatus for punching a stack of paper sheets.

### BACKGROUND OF THE INVENTION

A punching apparatus is widely used to punch holes in an edge margin of a stack of paper sheets to be filed. These paper sheets are bonded together by binding elastic loops formed on a plastic strip into the holes. FIG. 1 illustrates a conventional combined punching and binding machine shown in U.S. Pat. No. Des. 423,039, and such combined punching and binding machine principally comprises a levering rod 10, a punching structure 11 and a binding structure 12. The operation principle of the binding structure 12 is well known in the art and need not be further described in detail herein. The punching structure 11 has a receptacle (not shown) for positioning the paper sheets to be punched. When the levering rod 10 is pressed down, the desired holes are punched in the paper sheets. The levering rod 10 comprises an external-force receiving portion A, a depressing-force exerting portion B and a pivot portion C (not shown). The external-force receiving portion A is located at the free end of the levering rod 10 for applying thereto an external force T. The pivot portion C is located at the other end of the levering rod 10, coupled to the punching structure 11, and acting as a pivot for the levering rod 10 to rotate thereabout when the external force is exerted on the portion A. Meanwhile, a protrudent sustaining structure 101 of the levering rod 10 sustains against the punching structure 11 as the depressing-force exerting portion B to transmit the force T received from the portion A to the punching structure 11. With the increase of the external force, the depressing force exerted by the sustaining structure 101 to the punching structure 11 is getting more and more, and finally punches through the paper sheets.

Since the levering rod 10 of the prior art punching apparatus is almost linear, the external-force receiving portion A, the depressing-force exerting portion B and the pivot portion C are substantially aligned with one another. Such structure has at least the following drawbacks. If the levering rod 10 is not long enough, a relatively large force at the portion A will be required to provide a sufficient depressing force at the portion B. On the other hand, if the levering rod 10 is elongated to improve moment, a relatively large space will be required for packing or accommodating the apparatus because the overall height and volume of the apparatus are both increased. Furthermore, the sustaining structure is readily abraded after long-term use, and thus a relatively high external force may be required to punch holes.

Therefore, an improved punching apparatus is developed to overcome the above-mentioned drawbacks.

### SUMMARY OF THE INVENTION

It is an object of the present invention to provide a punching apparatus having improved leverage efficiency without increasing the packing or accommodating height or volume thereof.

It is another object of the present invention to provide a punching apparatus having a sustaining structure with a minimized abrasion problem.

In accordance with a first aspect of the present invention, there is provided a punching apparatus for punching holes in an article. The punching apparatus comprises a main body, a sustaining structure and a non-linear levering rod. The main body is used for receiving therein the article and exerting a punching force on the article to punch holes. The sustaining structure is used for transmitting a depressing force to the main body by depressing the main body to provide the punching force in response to an external force. The non-linear levering rod comprises a force-receiving portion, a pivot portion and a bent portion. The force-receiving portion is applied thereonto the external force. The pivot portion is coupled to the main body for allowing the levering rod to pivot relative to the main body in response to the external force. The bent portion is connected to the force-receiving portion and the pivot portion for keeping the force-receiving portion at a substantially horizontal level in a rest state. The non-linear levering rod is coupled to the sustaining structure for transmitting the sustaining structure to depress the main body while moving in response to the external force.

In an embodiment, the non-linear rod further includes a depressing-force exerting portion disposed between the pivot portion and the bent portion and coupled to the sustaining structure for transmitting the sustaining structure to move.

Preferably, the bent portion has a distance from the force-receiving portion farther than from the pivot portion.

In an embodiment, the sustaining structure rests on the main body when no external force is exerted on the force-receiving portion.

Preferably, the bent portion has an angle from 135 to 170 degrees, and more preferably from 145 to 160 degrees.

In an embodiment, the sustaining structure is a roller coupled to the non-linear levering rod.

In an embodiment, the article is a stack of paper sheets.

In accordance with a second aspect of the present invention, there is provided a punching apparatus for punching holes in an article. The punching apparatus comprises a main body, a non-linear levering rod and a roller. The main body is used for receiving therein the article and exerting a punching force on the article to punch holes. The non-linear levering rod comprises a force-receiving portion for being applied thereonto the external force, a pivot portion coupled to the main body for allowing the levering rod to pivot relative to the main body in response to the external force, a bent portion connected to the force-receiving portion and the pivot portion. The roller bearing is rotatably interfaced between the non-linear levering rod and the main body for depressing the main body in response -to the external force.

In an embodiment, the roller bearing rests on the main body when no external force is exerted on the force-receiving portion.

In an embodiment, the roller bearing is rotatably attached to the non-linear levering rod.

In accordance with a third aspect of the present invention, there is provided a punching apparatus for punching holes in an article. The punching apparatus comprises a main body, a sustaining structure, a non-linear levering rod and a depressing-force exerting portion. The main body is used for receiving therein the article and exerting a punching force on the article to punch holes. The sustaining structure is used for transmitting a depressing force to the main body by depressing the main body to provide the punching force in response to an external force. The non-linear levering rod comprises a force-receiving portion, a pivot portion and a bent portion. The force-receiving portion is applied thereonto the external force. The pivot portion is coupled to the main body for allowing the levering rod to pivot relative to the main body in response to the external force. The bent portion is connected to the force-receiving portion and the pivot portion for keeping the force-receiving portion at a substantially horizontal level in a rest state. The depressing-force exerting portion is disposed between the pivot portion and the bent portion and coupled to the sustaining structure for transmitting the sustaining structure to move. The non-linear levering rod transmits the sustaining structure to depress the main body while moving in response to the external force.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 shows a conventional punching and binding apparatus;

FIGS. 2(a) and 2(b) are perspective views of a punching apparatus according to a preferred embodiment of the present invention; and

FIG. 2(c) is a side view of the punching apparatus according to a preferred embodiment of the present invention.

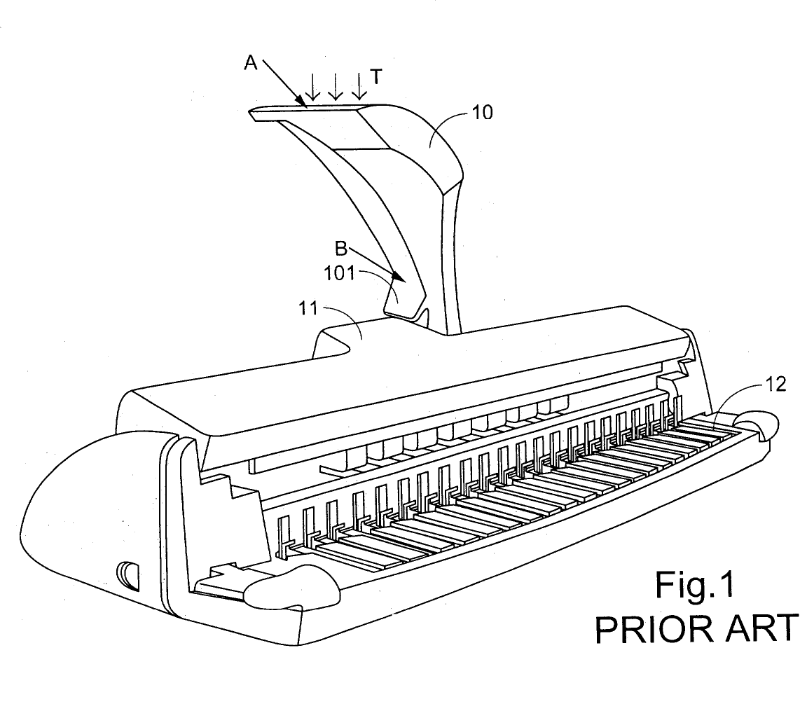

### DETAILED DESCRIPTION OF THE PREFERRED EMBODIMENT

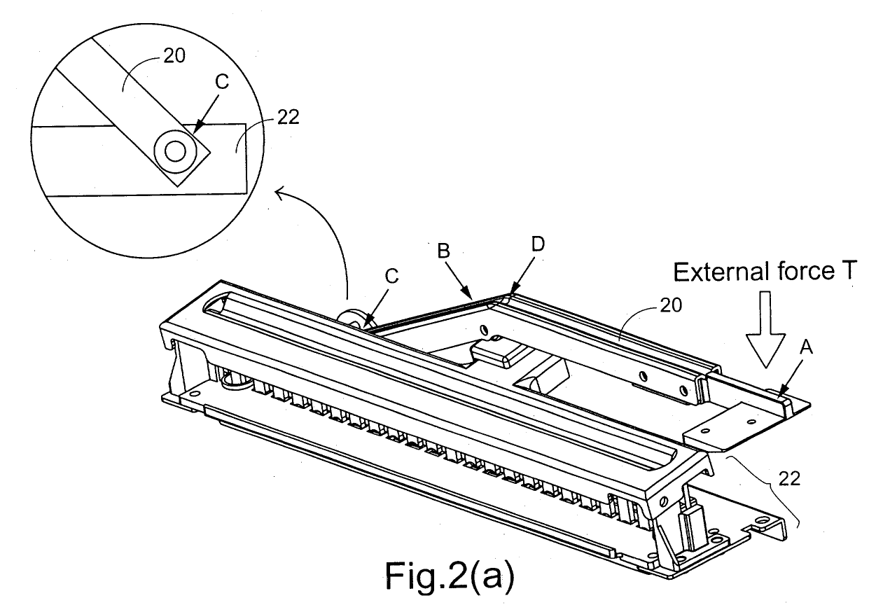

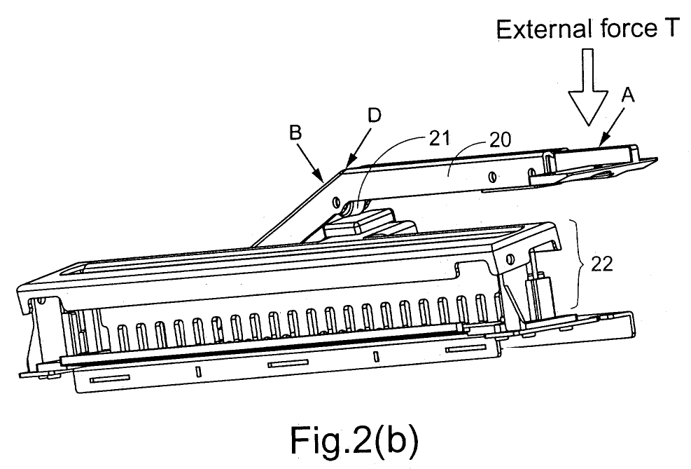

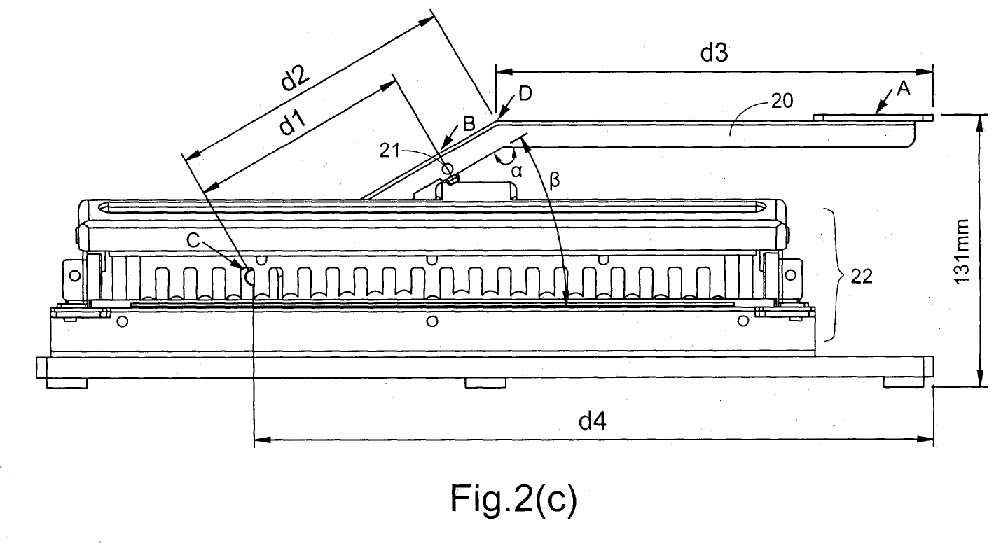

Please refer to FIGS. 2(a), 2(b) and 2(c). A punching apparatus for punching holes in a stack of paper sheets comprises a non-linear levering rod 20, a sustaining structure 21 and a main body 22.

The levering rod 20 comprises an external-force receiving portion A, a depressing-force exerting portion B, a pivot portion C and a bent portion D. The external-force receiving portion A is located at the free end of the levering rod 20 for applying thereonto an external force T. The depressing-force exerting portion B is disposed between the pivot portion C and the bent portion D and coupled to the sustaining structure 21 for transmitting the sustaining structure 21 to move. The pivot portion C is located at the other end of the levering rod 20, coupled to the main body 22, and acting as a pivot for the levering rod 20 to rotate thereabout when the external force T is exerted on the portion A. The bent portion D has a bent angle α from 135 to 170 degrees, and more preferably from 145 to 160 degrees, so that the levering rod 20 from the portions A to D is kept at a substantially horizontal level in a rest state.

As shown in FIG. 2(b), the sustaining structure 21 is a roller bearing rotatably coupled to the depressing-force exerting portion B of the levering rod 20 for depressing the main body 22 in response to the external force T. The roller bearing facilitates reducing abrasion on the main body 22 after a long-term use. Alternatively, the roller bearing can be rotatably coupled to the main body 22 for depressing the depressing-force exerting portion B of the levering rod 20 in response to the external force T such that the abrasive problem on the levering rod can also be solved. When no external force is exerted on the force-receiving portion A, the roller bearing rests on the main body 22. Whereas when the external force T is exerted, the depressing force exerted by the sustaining structure 21 to the main body 22 will punches through the paper sheets.

The dimensions of the punching apparatus can be exemplified with reference to FIG. 2(c). When no external force is exerted on the force-receiving portion A, the height of the overall punching apparatus is approximately 131 mm. The distance d1 between the depressing-force exerting portion B and the pivot portion C is approximately 132.4 mm. The distance d2 between the bent portion D and the pivot portion C is approximately 142.5 mm. The distance d3 between the force-receiving portion A and the bent portion D is approximately 229.7 mm. Thus, the ratio of d1:d2:d3 in this example is about 0.58:0.60: 1. Since the distance d3 is larger than the distance d2, the leverage of the levering rod 20 can be effectively increased. The projective length d4 of the levering rod 20 is approximately 363.2 mm. The elevation angle β of the levering rod 20 with respect to horizontal axis is approximately 24 degrees. Depending on the requirement of a user, the above dimensions can be varied.

Since the levering rod of the present punching apparatus is non-linear, the length of the levering rod can be largely increased to improve moment without increasing the packing or accommodating height or volume thereof. For example, the external force T for punching holes in the paper sheets can be exerted by only one hand of the user. The induced height or volume of the present punching apparatus is advantageous for storage and/or transportation. On the other hand, the roller bearing rotatably coupled to the levering rod or the main body facilitates reducing abrasion thereon after a long-term use.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A punching apparatus for punching holes in an article, comprising:
a main body for receiving therein said article and exerting a punching force on said article to punch holes;
a sustaining structure for transmitting a depressing force to said main body by depressing said main body to provide said punching force in response to an external force; and
a non-linear levering rod comprising a force-receiving portion for being applied thereonto said external force, a pivot portion coupled to said main body for allowing said levering rod to pivot relative to said main body in response to said external force, a bent portion connected to said force-receiving portion and said pivot portion for keeping said force-receiving portion at a substantially horizontal level in a rest state, said non-linear levering rod being coupled to said sustaining structure for transmitting said sustaining structure to depress said main body while moving in response to said external force.

2. The punching apparatus according to claim 1 wherein said non-linear rod further includes a depressing-force exerting portion disposed between said pivot portion and said bent portion and coupled to said sustaining structure for transmitting said sustaining structure to move.

3. The punching apparatus according to claim 1 wherein said bent portion has a distance from said force-receiving portion farther than from said pivot portion.

4. The punching apparatus according to claim 1 wherein said sustaining structure rests on said main body when no external force is exerted on said force-receiving portion.

5. The punching apparatus according to claim 1 wherein said bent portion has an angle from 135 to 170 degrees.

6. The punching apparatus according to claim 1 wherein said bent portion has an angle from 145 to 160 degrees.

7. The punching apparatus according to claim 1 wherein said sustaining structure is a roller coupled to said non-linear levering rod.

8. The punching apparatus according to claim 1 wherein said article is a stack of paper sheets.

9. A punching apparatus for punching holes in an article, comprising:
a main body for receiving therein said article and exerting a punching force on said article to punch holes;
a non-linear levering rod comprising a force-receiving portion for being applied thereonto said external force, a pivot portion coupled to said main body for allowing said levering rod to pivot relative to said main body in response to said external force, a bent portion connected to said force-receiving portion and said pivot portion; and
a roller bearing rotatably interfaced between said non-linear levering rod and said main body for depressing said main body in response to said external force.

10. The punching apparatus according to claim 9 wherein said non-linear rod further includes a depressing-force exerting portion disposed between said pivot portion and said bent portion and coupled to said roller bearing for transmitting said roller bearing to move.

11. The punching apparatus according to claim 9 wherein said bent portion has a distance from said force-receiving portion farther than from said pivot portion.

12. The punching apparatus according to claim 9 wherein said roller bearing rests on said main body when no external force is exerted on said force-receiving portion.

13. The punching apparatus according to claim 9 wherein said bent portion has an angle from 135 to 170 degrees.

14. The punching apparatus according to claim 9 wherein said bent portion has an angle from 145 to 160 degrees.

15. The punching apparatus according to claim 9 wherein said roller bearing is rotatably attached to said non-linear levering rod.

16. A punching apparatus for punching holes in an article, comprising:
a main body for receiving therein said article and exerting a punching force on said article to punch holes;
a sustaining structure for transmitting a depressing force to said main body by depressing said main body to provide said punching force in response to an external force; and
a non-linear levering rod comprising a force-receiving portion for being applied thereonto said external force, a pivot portion coupled to said main body for allowing said levering rod to pivot relative to said main body in response to said external force, a bent portion connected to said force-receiving portion and said pivot portion for keeping said force-receiving portion at a substantially horizontal level in a rest state, a depressing-force exerting portion disposed between said pivot portion and said bent portion and coupled to said sustaining structure for transmitting said sustaining structure to move, said non-linear levering rod transmitting said sustaining structure to depress said main body while moving in response to said external force.

17. The punching apparatus according to claim 16 wherein said bent portion has a distance from said force-receiving portion farther than from said pivot portion.

18. The punching apparatus according to claim 16 wherein said sustaining structure rests on said main body when no external force is exerted on said force-receiving portion.

19. The punching apparatus according to claim 16 wherein said sustaining structure is a roller coupled to said non-linear levering rod.
